(19) United States
(12) Patent Application Publication
(10) Pub. No.: US 2005/0228693 A1
(43) Pub. Date: Oct. 13, 2005

(54) Data exchange web services for medical device systems

(76) Inventors: James D. Webb, Maple Grove, MN (US); Bruce K. Krautbauer, Blaine, MN (US); James E. Willenbring, St. Paul, MN (US)

Correspondence Address: MEDTRONIC, INC., 710 MEDTRONIC PARKWAY NE, MS-LC340, MINNEAPOLIS, MN, 55432-5604, US

(21) Appl. No.: 10/821,499

(22) Filed: Apr. 9, 2004

(51) Int. Cl. G06F 17/60

(52) U.S. Cl. 705/2

(57) ABSTRACT

A remote monitoring medical device system includes a medical device system which may further include an implantable medical device and/or an external medical device having a communication connection and one or more remote data handling systems having compatible communication connections such as a centralized database located on a host server or a remote third party or clinical data handling system. Web services may be installed and run on an implantable or external medical device or a data handling system and may be invoked locally by applications running on the system component or invoked remotely by another system component. Web services provide translation, analysis and/or storage and retrieval of data used by the remote monitoring medical device system.

### FIELD OF THE INVENTION

The present invention relates generally to medical device systems and specifically pertains to the provision of web services for translating, storage and analysis of data obtained by medical device systems.

### BACKGROUND OF THE INVENTION

Communication systems have been introduced for transferring information between an implantable medical device (IMD) and a remote location. The Medtronic CareLink™ Network, for example, allows a patient to transfer data from his or her implanted device to a home monitor unit connected to standard phone line for Internet transmission to the CareLink Network. Medical personnel at the patient's clinical center are able to remotely review data obtained from the implanted device which previously would have required an office visit to uplink stored data to an external programmer. Remote monitoring medical device systems are generally described in U.S. Pat. No. 6,250,309 issued to Krichen et al., U.S. Pat. No. 6,480,745 issued to Nelson, U.S. Pat. No. 6,418,346 issued to Nelson et al., and U.S. Pat. No. 6,497,655 issued to Linberg et al., all of which patents are incorporated herein by reference in their entirety.

Remote monitoring using Internet or other network data transfer has many advantages in monitoring patient condition and managing patient care. However, such systems generally use proprietary software making implementation of software limited to certain environments or hardware and transfer of data into other environments cumbersome. Installation and distribution of new software, e.g., to incorporate new features or provide translation to a foreign language, generally requires the use of transportable data storage mediums like CD-ROM. A central database provided on a host server can be made accessible by authorized users, enabling remote monitoring. However, the use of a host server for maintaining a central database requires patient data to be transferred to and stored on the host server, which may be undesirable with regard to patient privacy policies. Furthermore, data or analyses obtained using software installed on a host server may be viewable only within a web browser and not easily transferred to third party or clinic-specific charting systems or databases. Therefore, while the provision of remote monitoring of medical systems is highly desirable, certain limitations remain with regard to the use and transferability of data from remote locations.

### BRIEF SUMMARY OF THE INVENTION

The present invention provides a data exchange system for use with medical device systems wherein web services are implemented to facilitate data exchange functions. Web services are programmable application logic services accessible using standard Internet protocols such as Hypertext Transfer Protocol (HTTP). Web services generally use a standardized Extensible Markup Language (XML) messaging system that allow services or software to be located and invoked regardless of the operating system or programming language used to invoke the service. Data exchange web services for use with medical device systems may run on a server at a network hosting facility, on a gateway to a clinical or third party remote system, or on a medical device.

The medical device system may be an implantable medical device system including an implantable medical device (IMD) and an external medical device (EMD), e.g., a home monitor or programmer, having telemetric communication with the IMD for retrieving device- or patient-related data stored by the IMD. The medical device system may alternatively be an external medical device system including a bedside or portable EMD for patient monitoring or therapy delivery. In either an internal or external medical device system, an associated EMD is telecommunications or Internet-enabled for transferring data via the Internet, a telecommunications or other network and for optionally invoking data exchange web services. In implantable systems, the IMD may be provided with a wireless communication link to allow the IMD to invoke data exchange web services or make data exchange web services available to an IMD or a remote data handling system. Data stored by the IMD and/or EMD may be transferred to a remote data handling system wherein a host server or third-party system gateway may also invoke data exchange web services to allow interoperability of the IMD, EMD, host server and third party system.

Data exchange web services may include one or more constituent web services as well as multi-function web services provided for performing more complex or multi-step services utilizing one or more of the constituent web services. In one embodiment, constituent data exchange web services include a translation web service, an analysis web service, and a storage web service. A translation web service receives data as input in a given format and returns the data after translating it to a different, requested format. An analysis web service performs a selected data analysis on a data set and returns a result. An analysis web service may be provided for detecting device- or patient-related conditions that warrant clinical attention or for recommending programmable therapy parameters in systems capable of delivering a therapy. A storage web service provides data retrieval and storage functions. Data may be added to or retrieved from a remote data storage system or a data storage system provided by the web service wherein data may be stored indefinitely or until it is retrieved by another user. Multi-function web services may be provided which invoke the translation, storage and/or analysis web services.

Additional services that may be provided by data exchange web services may include, but are not limited to: security functions such as authentication, validation, encryption, and decryption functions; control of web service invocation by controlling the setup, scheduling, initiation, and suspension of web services by invoking applications or other web services; and administrative services such as updating patient or device records, scheduling, and billing.

### BRIEF DESCRIPTION OF THE DRAWINGS

FIG. 1 is an illustration of the type of environment in which the present invention may be practiced.

FIG. 2A is a simplified schematic block diagram illustrating an implementation of data exchange web services in the operating environment of FIG. 1.

FIG. 2B is a simplified schematic block diagram illustrating an alternative implementation of web services in the operating environment of FIG. 1.

FIG. 3 is a schematic diagram illustrating data exchange web services used to integrate data storage and services between a host server or device applications and a remote system.

FIG. 4 is a block diagram summarizing methods included in a translation web service in accordance with one embodiment of the present invention.

FIG. 5A is a block diagram summarizing methods included in an analysis web service in accordance with one embodiment of the present invention.

FIG. 5B is a block diagram summarizing methods included in an analysis web service for analyzing programmed parameter data from a medical device.

FIG. 6A is a block diagram summarizing methods included in a storage web service for retrieving data from a data storage system in accordance with one embodiment of the present invention.

FIG. 6B is a block diagram summarizing methods included in a storage web service for writing data to a data storage system in accordance with one embodiment of the present invention.

FIG. 7 is a block diagram summarizing methods that may be included in multifunction web services in accordance with the present invention.

FIG. 8A is a schematic diagram summarizing the steps performed in invoking and executing a web service for informing a clinical charting system of new data received by a central database.

FIG. 8B is a schematic diagram summarizing operations performed in invoking and executing a web service in a “pull” fashion.

FIG. 9 is a schematic diagram summarizing operations performed in invoking and executing a web service for retrieving monitoring session data.

FIG. 10 is a schematic diagram summarizing operations performed in invoking and executing an enrollment web service for automatically registering patients enrolled in a clinical charting system in a central database.

### DETAILED DESCRIPTION OF THE PREFERRED EMBODIMENTS

As indicated above, one embodiment of the present invention is directed toward providing a data exchange system for use with medical device systems that utilizes web services to allow interoperability and collaboration between a medical device system and one or more data handling systems, which may include a host server for a centralized database and/or one or more third party or clinical data storage systems. The use of web services has grown in business applications allowing business functionality to be Internet accessible through a consistent set of interfaces and protocols. The implementation of web services in a data exchange system for use with medical devices allows data and analyses to be shared across data handling systems while protecting proprietary codes used by the data handling systems and without having to develop or install customized software on these data handling systems.

Data exchange web services provided in accordance with the present invention may be invoked by applications running on an implantable or external medical device, on a central database server at a hosting facility, or gateways or servers within clinics, or other third party remote systems. Web services provide an interface between the various hardware utilized in retrieving, transporting, storing, analyzing and displaying medical data regardless of the type of operating systems implemented or data formats used by applications running on the various hardware.

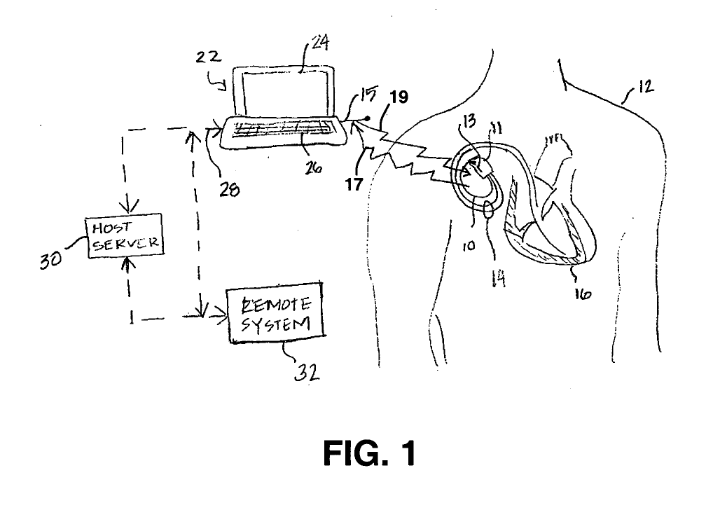

FIG. 1 is an illustration of the type of environment in which the present invention may be practiced. A medical device system is shown including an IMD 10 and an EMD 22. IMD 10 is shown implanted in the body of a patient 12. The present invention may be implemented for use with a variety of programmable IMDs, including cardiac stimulation devices, cardiac or other physiological monitoring devices, neuromuscular stimulators, implantable drug pumps, or the like. For the sake of illustration, IMD 10 is shown here as a cardiac stimulation device coupled to a set of leads 14 used for positioning electrodes and optionally other physiological sensors in operative relation to the patient's heart 16. Leads 14 are coupled to IMD 10 via a connector block 11. Exemplary cardiac stimulation or monitoring devices with which the present invention may be employed are disclosed in U.S. Pat. No. 5,545,186 issued to Olson, et al., U.S. Pat. No. 5,987,352 issued to Klein et al., and U.S. Pat. No. 6,438,408 issued to Mulligan et al., all of which patents are incorporated herein by reference in their entirety.

IMD 10 contains an operating system that may employ a microcomputer or a digital state machine for timing cardiac sensing and stimulation functions in accordance with a programmed operating mode. The IMD 10 also contains sense amplifiers for detecting cardiac signals, patient activity sensors or other physiologic sensors for sensing the need for cardiac output, and pulse generating output circuits for delivering cardiac stimulation pulses to at least one chamber of the heart 16 under control of the operating system in a manner well known in the prior art. The operating system includes memory registers or RAM for storing a variety of programmed-in operating mode and parameter values that are used by the operating system. The memory registers or RAM may also be used for storing data compiled from sensed cardiac activity and/or relating to device operating history or sensed physiologic parameters for telemetry out on receipt of a retrieval or interrogation instruction. All of these functions and operations are well known in the art, and many are employed in other programmable IMDs to store operating commands and data for controlling device operation and for later retrieval to diagnose device function or patient condition.

IMD 10 is in telemetric communication with EMD 22 to allow data stored or being acquired by IMD 10 to be retrieved by EMD 22 during an interrogation monitoring session, or other communication session. Exemplary external devices that may be located in a patient's home having telemetric communication with an IMD are disclosed in U.S. Pat. No. 6,647,229 issued to Bourget and U.S. Pat. No. 6,249,703, issued to Stanton, et al., both of which patents are incorporated herein by reference in their entirety. Programming commands or data are transmitted between an IMD RF telemetry antenna 13 and an external RF telemetry antenna 15 associated with the external device 22. The external RF telemetry antenna 15 may be contained in a programmer RF head so that it can be located close to the patient's skin overlying the IMD 10. Such programmer RF heads are well known in the art. See for example U.S. Pat. No. 4,550,370 issued to Baker, incorporated herein by reference in its entirety. The external device 22 may be designed to universally program IMDs that employ conventional ferrite core, wire coil, RF telemetry antennas known in the prior art and therefore also have a conventional programmer RF head and associated software for selective use with such IMDs.

Alternatively, the external RF telemetry antenna 15 can be located on the case of the external device 22, and the external device 22 can be located some distance away from the patient 12. For example, RF telemetry antenna 15 may be integrated with external device 22 and external device 22 may be located a few meters or so away from the patient 12 and utilize long-range telemetry systems. Such long-range telemetry systems that facilitate passive telemetry transmission may occur between IMD 10 and external device 22 without patient interaction when IMD 10 is within a communication range of external device 22. Thus, patient 12 may be active, e.g., partaking in normal household activities or exercising during an uplink telemetry interrogation of real time ECG or device or physiologic parameters. Telemetry systems that do not require the use of a programmer RF head are generally disclosed in U.S. Pat. No. 6,240,317 Villaseca et al., U.S. Pat. No. 6,169,925 issued to Villaseca et al., and U.S. Pat. No. 6,482,154, issued to Haubrich et al., all of which patents are incorporated herein by reference in their entirety.

In an uplink telemetry transmission 17, the external RF telemetry antenna 15 operates as a telemetry receiver antenna, and the IMD RF telemetry antenna 13 operates as a telemetry transmitter antenna. Conversely, in a downlink telemetry transmission 19, the external RF telemetry antenna 15 operates as a telemetry transmitter antenna, and the IMD RF telemetry antenna 13 operates as a telemetry receiver antenna. Both RF telemetry antennas are coupled to a transceiver comprising a transmitter and a receiver. Any of a number of suitable programming and telemetry methodologies known in the art may be employed such as the RF encoded telemetry signal system generally disclosed in U.S. Pat. No. 5,312,453 issued to Wyborny, et al., incorporated herein by reference in its entirety.

External device 22 is shown in FIG. 1 to be embodied as a “programmer” used in conjunction with an IMD. Programmers are well known in the art and generally include a display 24, user interface 26, and a control system typically in the form of one or more microprocessors in addition to the telemetry circuitry described above. However, the present invention is not limited to being practiced with an IMD system wherein the external device functions as an associated programmer or home monitor. The present invention may alternatively be practiced with an external medical device system wherein a bedside or portable device performs physiological monitoring or therapy delivery functions. For example, EMD 22 may alternatively be embodied as a bedside monitoring console that may include ECG monitoring, blood pressure monitoring, oxygen saturation monitoring, carbon dioxide monitoring, or other physiological signal monitoring.

Whether EMD 22 is associated with an internal or external medical device system, EMD 22 is provided with a communication connection 28, which may be an Internet, telecommunications, or other network connection, that allows external device 22 to transfer information to a database on host server 30, provided by a web service, or on another remote system 32 which may be a clinical medical records system or other third party database or data analysis system. EMD 22 may acquire and temporarily store data related to the status or function of EMD 22 or IMD 10, including operating parameters or device diagnostics, and physiological data relating to a patient condition.

Host server 30 may represent a proprietary system for remotely monitoring an IMD system such as the Medtronic CareLink™ Network, which allows a patient to transfer data from his or her implanted device to a home monitor unit connected to standard phone line for modem transmission to the CareLink Network. Medical personnel at the patient's clinical center are able to review data stored in the implanted device and transferred to the CareLink Network, which previously would have required an office visit to uplink stored data to an external programmer.

Remote system 32 may be a clinical charting system, which in accordance with the present invention, may access data or analyses stored in on host server 30 or directly from EMD 22 or IMD 10 by utilizing web services. Remote system 32 may alternatively be another third party system authorized to obtain device or patient-related data for analysis or record-keeping such as a third party clinical decision support system or another medical device manufacturer. The present invention advantageously provides a transparent interface between one or more remote locations by enabling applications running on IMD 10, external device 22, host server 30, or remote system 32 to invoke web services for basic functions, such as translation, storage or analysis, or higher-level, multiple function services.

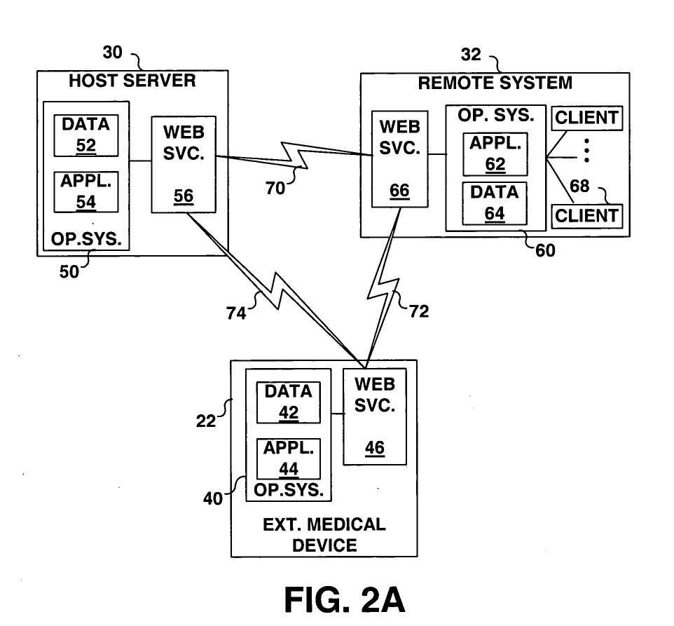

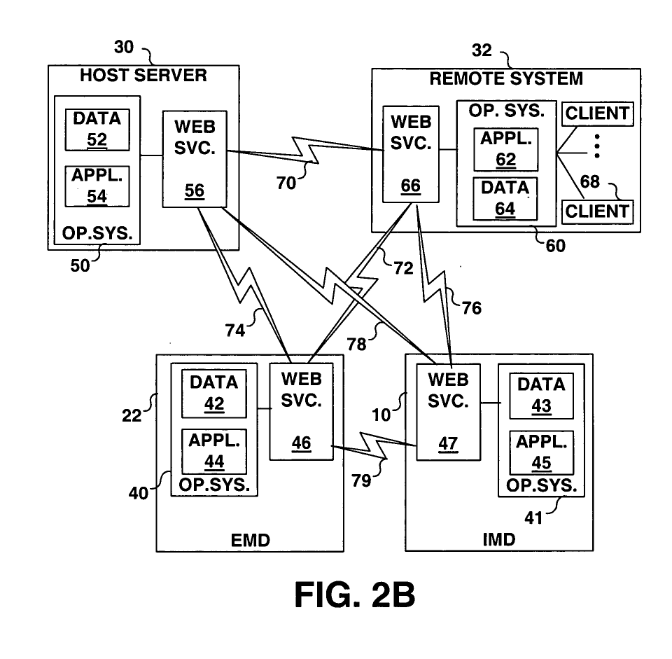

FIG. 2A is a simplified schematic block diagram illustrating an implementation of web services in the operating environment of FIG. 1. EMD 22 contains an operating system 40 on which applications 44 installed in EMD 22 may be executed. Data obtained by EMD 20 or retrieved from IMD 10 may be stored in associated data storage memory 42 and utilized by various applications 44 for transferring, analyzing, displaying or storage operations or for controlling device functions. Web services 46 are installed on EMD 20 and may be invoked locally by applications 44 as needed to run on EMD 22. Web services 46 are also available, as will be described below, via communication links 72 and 74 to provide services to applications running on host server 30 or remote system 32.

Data exchange web services are intended to provide interoperability of different components included in a remote monitoring medical device system, allowing transfer, storage, analysis or other data exchange functions to be performed smoothly across different hardware architectures. However, data exchange services may also be utilized locally by a component within the overall system to perform data handling operations within the given component. In the system shown in FIGS. 1 and 2A and 2B, remote system 32 and host server 30 are typically located at a different physical location than EMD 22 or IMD 10 to allow remote programming and monitoring operations. However, with respect to the present invention, these system components may also be located at the same physical location, for example in a clinic office. Invoking a web service “locally”, as used herein, refers to running a web service installed on the invoking system component. Invoking a web service “remotely”, as used herein, refers to running a web service installed on a system component upon the request of a different system component, regardless of the physical location of the two system components.

Host server 30 may utilize an operating system 50 that is the same or different from operating system 40 of EMD 22. Applications 54 installed on server 30 may likewise be implemented in a different language than applications 44 installed on EMD 22, but may still invoke web services 46 running on EMD 22 via communication link 74. Data storage 52 may be provided as a central relational database system for compilation of data retrieved from multiple medical devices, implanted in patients enrolled at several different clinical centers. Data storage 52 may additionally or alternatively include a collection of files or XML databases. Applications 54 executed on host server 30 may utilize data stored in data storage 52 or retrieve new data from EMD 22 or remote system 32. Web services 56 installed on host server 30 may be invoked locally by the various applications 54 implemented on server 30, but are also available to remote system 32 and EMD 22 via communication links 70 and 74 as will be described in greater detail below.

Similarly, remote system 32 includes an operating system 60 and applications 62 which may or may not utilize the same operating system and application language used by host server 30 or EMD 22. Web services 66 may also be installed on remote system 32 and invoked locally by applications 62 or remotely by host server 30 or EMD 22 via communication links 70 or 72. Remote system 32 may operate to manage a third party or clinical data storage system 64 for one or more clients 68.

Web services are generally written in Extensible Markup Language (XML), which provides a universal standard for representing data making XML programs interoperable between hardware and operating systems. Thus, the operating systems and application languages utilized by EMD 22, host server 30 and remote system 32 may be different, yet web services installed at any of these locations is accessible by another authorized system. A web service 46, 56, or 66 may be invoked by another system component (EMD 22, host server 30, or remote system 32) via communication links 70, 72 or 74 using a Hypertext Transfer Protocol (HTTP), Simple Object Access Protocol (SOAP), Web Services Description Language (WSDL), Universal Discovery, Description and Integration (UDDI), messaging software, or any other technologies or combinations of technologies for identifying a web service, its location, and the procedures and data available.

FIG. 2B is a simplified schematic block diagram illustrating an alternative implementation of web services in the operating environment of FIG. 1. Web services 47 may be installed on IMD 10 and invoked to run locally on IMD 10 by applications 45 executed under the control of IMD operating system 41. Web services 47 may perform various data exchange functions, as will be described in greater detail below, such as translation, analysis, or storage of data in data storage 43 on IMD 10. EMD 22 may invoke web services 47 via a telemetry link 79. Likewise, IMD 10 may invoke web services 46 installed on EMD 22 via telemetry link 79.

Web services 47 installed on IMD 10 may be made available to host server 30 and remote system 32 using EMD 22 as a communication conduit. A web service request from host server 30 or remote system 32 may be transferred via communication links 74 or 72 to EMD 22 and forwarded to IMD 10 via telemetry link 79. Alternatively, IMD 10 may be provided with wireless communication links 78 and 76 to allow direct interfacing of IMD 10 with host server 30 and remote system 32. IMD 10 may then invoke web services 56 and 66 on host server 30 and remote system 32, respectively, via communication links 78 and 76. Conversely, host server 30 or remote system 32 may invoke web services 47 on IMD 10 via communication links 78 and 76.

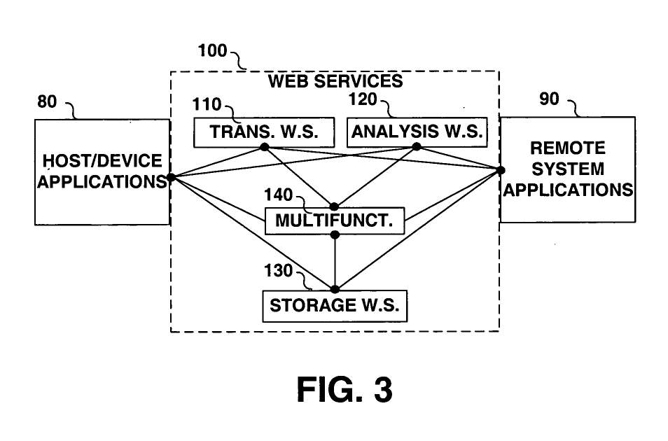

FIG. 3 is a schematic diagram illustrating data exchange web services used to integrate data storage and services between a host server or device applications and a remote system. As described above, web services 100 may be invoked by applications 80 running on a host server or a medical device or by applications 90 running on a remote, third party or clinical, data handling system. Until now, data transferred between a medical device and a central data storage system on a host server has generally been done so using proprietary applications and data formatting. Such data may be viewable by a clinician, e.g., via a web browser, however, transferring such data into a clinical charting system, medical record, or other remote systems can become a laborious task due to incompatible data formatting. Data exchange web services 100 allow for complete interoperability and collaboration between clinical charting systems or other remote data handling systems and the host server data storage and/or medical device.

Web services 100 will generally include constituent services for performing basic data exchange functions, which may be invoked individually or combined to perform more complex or multi-step tasks in multifunction web services. Preferably, the constituent web services for use with a medical device system include a translation web service 110, an analysis web service 120, and a storage web service 130. Multifunction web services 140 may be provided which call upon one or more of the constituent services 110, 120 or 130. As described previously, the family of web services 100 may be implemented in a variety of physical locations including on an external or implantable medical device, on a host server, or on a server or gateway of a remote system, with each of these system components having compatible communication connections, i.e. Internet, telecommunication, or other network connections, for allowing access to or invocation of web services.

As such, the constituent web services (translation web service 110, analysis web service 120, and storage web service 130) may be invoked directly by applications 80 running on a medical device or host server or applications 90 running on a remote system. The constituent web services 110, 120, and 130 may also be invoked indirectly by invoking a multifunction web service 140, which in turn invokes constituent web service 110, 120 and/or 130 in performing a multi-step service.

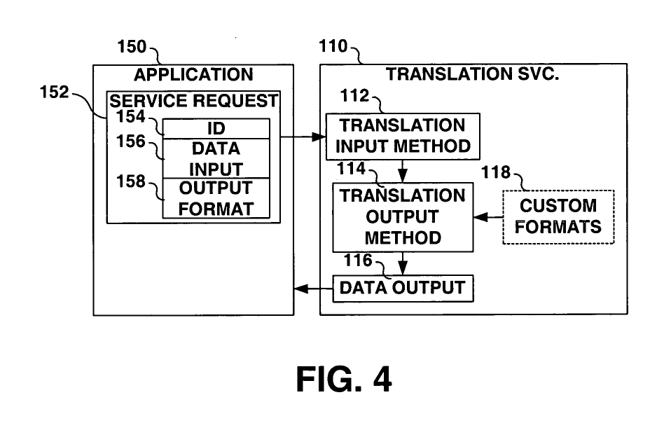

FIG. 4 is a block diagram summarizing methods included in translation web service 104 in accordance with one embodiment of the present invention. An application 150, which may be running on a medical device, a host server, or a third party, remote system, executes a translation service request 152 which locates a translation web service 110. After the translation web service is located, service request 152 communicates the format of the data to be translated in a self-describing identification (ID) 154 and provides the data input 156 to be translated. A separate translation service may be located for each type of input data format and therefore be located based on the type of translation request being made. Alternatively, the input format ID may be provided as parameters used by the input method 112 of the translation service 110 to allow the input data 156 to be read.

Output format request 158 may cause a particular output method 114 to be utilized depending on the requested output format or provide parameters to be used by output method 114 for translating data to a requested format. Output method 114 writes the data output 116 in the requested format. The formatted data output is then transferred back to the invoking application 150. Available formats may include, but are not limited to, American Standard Code for Information Interchange (ASCII) formats, any XML format including viewable XML forms, a printable portable document format (PDF), viewable Hypertext Markup Language (HTML), and scalable vector graphic (SVG) files for viewable graphics.

Furthermore, customized style sheets may be made available to produce customized views or data formats configured specifically for interoperability with third party or clinical applications. Such custom format translation services 118 may be embedded within the translation web service 110 and utilized by the output method 114 or provided separately as an individual translation web service. One type of custom method may involve a translation web service method for translating data and information into a foreign language and associated customary measurement units. By providing foreign language translation web services, data may be retrieved and presented in a desired language without having to distribute and install customized software for use in different countries.

Numerous types of data may be translated by a translation web service 110, including medical device-related and patient-related data. The types of data provided for translation by a translation web service will depend on the type of medical device system used, however the input and output formats of such data will not be limited by the web service. For example, with regard to the IMD system shown in FIG. 1, data that may be provided for translation may include data retrieved from IMD 10 during a device interrogation such as programmed operating parameters, results from automated device diagnostics such as lead impedance testing or pacing threshold searches, stored episode data, e.g. relating to detected arrhythmias, stored therapy delivery data, and stored physiological data. Stored or real-time data such as EGM recordings or event marker data may also be retrieved and translated to a desired format.

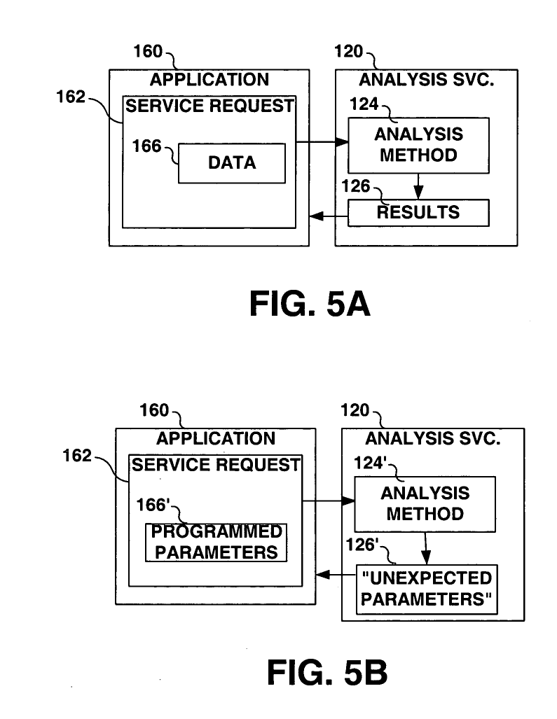

FIG. 5A is a block diagram summarizing methods included in analysis web services in accordance with one embodiment of the present invention. An application 160 running on a medical device, host server, or remote system may request an analysis service 120, available locally or via an Internet, telecommunications or other network connection. The service request 162 locates the analysis web service 120 capable of performing the desired analysis. The data to be analyzed may be provided directly as data input 166 by the service request 162. Analysis web service 120 then executes analysis method 124 and produces a results file 126 to be transferred back to the invoking application 160.

It is recognized that depending on the type of data to be analyzed, a number of analysis methods may be implemented using web services. One analysis method that is desirable is an analysis method for identifying potentially erroneous or abnormal programming of medical device operating parameters. For example, in an implantable cardioverter defibrillator (ICD) device, if arrhythmia detection features were inadvertently programmed to be “OFF” or arrhythmia therapies disabled, an analysis method may identify these “unexpected” programmed parameters and flag them to the attention of a clinician. As shown in FIG. 5B, service request 162 may provide programmed parameter data 166′ retrieved from a medical device and request an analysis of the parameters. Analysis web service 120 then executes analysis method 124′ and produces a results file 126′ listing “unexpected” programmed parameters for transfer back to invoking application 160.

Results of automated device diagnostics or physiological data or trends may also be analyzed to determine if such data represent a potentially clinically significant change or event. An analysis web service 120 may identify and flag such events for further attention thereby assisting clinicians in the arduous task of monitoring for important events within large amounts of data. An analysis method may additionally provide medical device programming recommendations based on analysis results included in the result output file 126.

In a basic embodiment, analysis web service 120 receives and returns data in an XML format. However, data received for analysis may often be in a different, device or system-specific format, and analysis results may be required in a specific format for usability by the invoking application. As such, analysis web service 120 may be combined with translation web service 110 in a multi-function web service. The multi-function web service would allow translation of a specific input data format to a format appropriate for analysis by the analysis web service, and translation of analysis results to a desired output format.

Furthermore, the invoking application 160 may not have possession of the data needed for a desired analysis. In such cases, a multi-function web service may include both storage web services for retrieving data to be analyzed from a remote location and the analysis web service for analyzing the requested data. Examples of other multi-function web services will be described below.

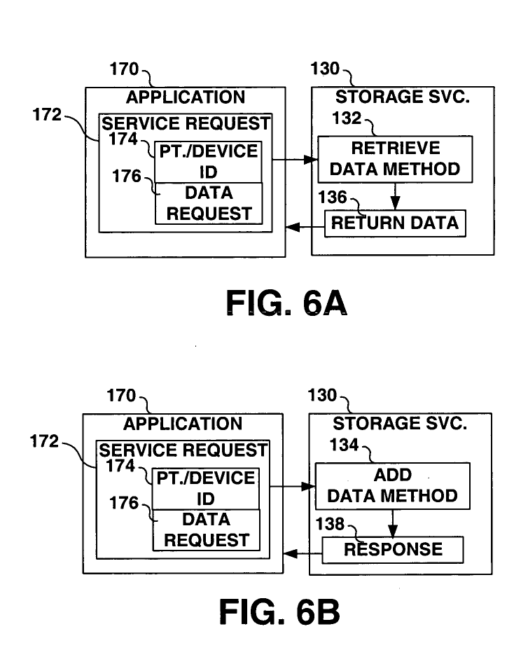

FIG. 6A is a block diagram summarizing methods included in storage web service 130 used for retrieving data from a data storage system in accordance with one embodiment of the present invention. An application 170, which may be running on a medical device, host server or remote system, may invoke a storage web service 130 by issuing a service request 172 to locate the storage web service 130.

A patient or device identification 174 is provided for identifying the patient(s), device type, and/or device serial number for which a data retrieval service is to be performed. The service request may also communicate the type of data being requested for retrieval which may include data retrieved from an implanted device during an interrogation session, device-related or physiological data stored in a medical device between interrogation sessions, patient-related data, programmed operating parameter data, other patient charting data such as medications or clinical events, or other data or XML files. Data request 176 may additionally specify a time period for which data is to be retrieved. Storage web service 130 transfers the retrieved data in a return data file 136 back to the invoking application 170. Thus storage web service 130 may retrieve requested data from a data storage location and return the retrieved data to the invoking application.

Storage web service 130 may provide both data storage and retrieval services as indicated previously. Storage web service 130 may manage the writing and retrieval of data to and from a data storage system provided by storage web service 130 or located at a host server or other remote system. A data storage system may be, for example, in the form of a relational database, a collection of files, an XML database or collection of files, or a medical device.

FIG. 6B is a block diagram summarizing methods included in storage web service 130 for writing data to a data storage system in accordance with one embodiment of the present invention. Service request 172 may be issued by invoking application 170 requesting data to be written to a data storage system. Service request 172 may include identification code 174 to identify a patient or medical device for which data is to be stored in a relational database and/or code identifying the data storage system to which data is to be written. Data request 176 included in service request 172 provides the data to be stored by storage web service 130.

Storage web service 130 utilizes an add data method 134 for writing the requested data to a designated data storage system. Storage web service 130 may optionally issue a response 138 to invoking application 170 confirming execution of the data storage service. In one example, storage service 130 is invoked by an application 170 running on a medical device wherein data retrieved during an interrogation session is transferred to storage web service 130 by service request 172 for storage in a central database. Storage web service 130 may provide the central database or transfer data to a specified remote database.

Alternatively, data request 176 may indicate the type of data to be stored by storage web service 130, but may not provide the data directly. In this case the requested storage service would be provided by a multifunction service that first invokes storage web service 130 to retrieve the specified data using the retrieve data method 132 and then invokes storage web service 130 to write the data to the designated data storage system using add data method 134.

Thus storage web service 130 may be used to retrieve requested data and return it to an invoking application, write data provided directly by a storage service request to a specified data storage system, or, in a multifunction service as will be described further below, retrieve requested data and write the retrieved data to a specified data storage system.

Table I is a list of exemplary storage web service methods that may be requested and the function performed. The list provided in Table I is not intended to be exclusive but is provided to illustrate the various types of storage or retrieval methods that may be provided by storage web services 130 implemented in conjunction with a medical device system. It is recognized that, depending on the type of medical device and data stored by the device, numerous variations of specific storage and retrieval web services may be conceived.

TABLE I
Storage web service methods and function.

| STORAGE METHOD | FUNCTION |
|---|---|
| AddDataFromURL | Adds an XML data file specified by the Uniform |
| | Resource Locator (URL) to a storage system. |
| AddData | Adds the data passed in the service request to |
| | a data storage system. |
| GetEpisodes | Returns a list of stored episodes for the |
| | specified device type and serial number or |
| | patient ID. |
| GetSessions | Returns a list of interrogation sessions for the |
| | specified device type and serial number or |
| | patient ID. |
| GetTrends | Returns a list of trends for the specified device |
| | type and serial number or patient ID. |
| GetLatestSession | Returns the latest interrogation session data for |
| | the specified device type and serial number or |
| | patient ID. |
| GetSerialNumbers | Returns a list of serial numbers for the specified |
| | device type contained in data storage system. |
| GetPatientInformation | Returns patient information for a specified |
| | device serial number or patient ID. |
| GetPatients | Returns a list of patients contained in a data |
| | storage system for specified device type. |

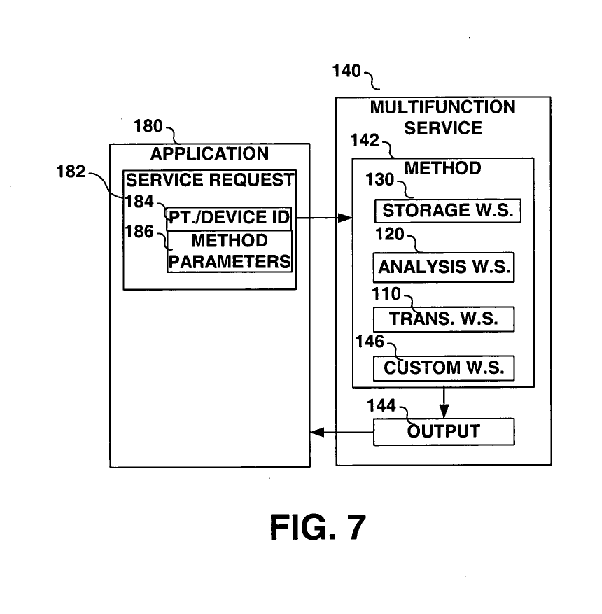

FIG. 7 is a block diagram summarizing methods that may be included in multifunction web services in accordance with the present invention. A multifunction web service 140 utilizes the constituent services, storage web service 130, analysis web service 120 and/or translation web service 110, to perform a multi-step function upon receiving a service request 182 from an invoking application 180. The service request 182 will generally communicate patient or device identification 184 for which a service is needed. Depending on the service requested, the service request 182 may additionally communicate method parameters 186 to be used by the multifunction web service method 142 in performing the requested service. For example, method parameters relating to input data format, output data format, analysis type, storage destination or the like may be communicated to the multifunction web service 140.

Multifunction web service method 142 may invoke one or more of the constituent translation, analysis and storage services 110, 120, and 130 and may invoke custom web services 146 for executing a particular multifunction service. Upon invoking a constituent web services 110, 120, 130 or custom web service 146, multifunction service 140 may transfer method parameters received from service request 182 or generated by multifunction service 140. Output data 144 may be returned back to the original invoking application 180 in a requested format. Alternatively, output 144 may be written to a requested storage location in a requested format rather than returned to application 180.

In FIG. 7, arrows indicating an order of invocation of the constituent web services 110, 120 and 130 and custom service 146 are not shown because the order in which the constituent web services 110, 120, and 130 and any custom service 146 are utilized will depend on the multifunction web service being performed. Table II lists a number of exemplary multifunction web services. This list of multifunction web services is intended to be illustrative of the types of multifunction web services that may be implemented using one, two or more of the constituent translation, storage and analysis web services. Method parameters that may be included in a particular multifunction service request are shown parenthetically following a corresponding multi-function method in Table II. It is recognized that numerous types of multifunction web services may be conceived and implemented by one having skill in the art based on the structure taught herein for use with many different types of implantable or external medical device systems.

| MULTIFUNCTION | |
|---|---|
| METHOD (METHOD | |
| PARAMETERS) | FUNCTION |
| ImportNewSessionData | Translates interrogation session data to a |
| (SessionData) | requested storage format using the translation |
| | web service and writes data to a storage |
| | system using the storage web service. |
| ViewSessionData | Retrieves interrogation session data using the |
| (DeviceID, SessionDate) | storage web service and translates to a |
| | viewable web page using the translation web |
| | service. May invoke analysis web service to |
| | add analysis results to the views. |
| RetrieveSessionData | Retrieves interrogation session data using the |
| (DeviceID, SessionDate, | storage web service for a particular device |
| Format) | and date and translates to the requested |
| | format using translation web service. |
| ViewPatientsData | Retrieves all data stored for a requested |
| (PatientID/DeviceID) | patient using the storage web service, |
| | translates into a viewable web page using |
| | service. Analysis web service may be |
| | invoked the translation web to add |
| | analysis results to the views. |
| RetrievePatientData | Retrieves all data for a requested patient |
| (PatientID/DeviceID, | using the storage web service and |
| Format) | translates data to a requested format |
| | using the translation web service and |
| | returns formatted data. |
| AnalyzeStoredSessionData | Retrieves data for device and date requested |
| (DeviceID, SessionDate, | using storage web service, analyzes data |
| Format) | using analysis web service, translates |
| | analysis results to the requested format |
| | using the translation web service and |
| | returns formatted results. |

Thus, multi-function web services that call upon the constituent translation, storage and analysis web services provide a transparent interface between different system components for performing data exchange and analysis functions. Analysis, storage and retrieval functions can be performed without requiring a user to intervene by first having to translate or manually enter data to a device- or application specific format. Data exchange web services provide a flexible interface between remote systems allowing functions to be performed that might otherwise require dedicated software installations on individual system components.

Currently there is a particular need to provide interoperability between clinical charting systems and a proprietary central database provided on a host server, which allows remote monitoring of implantable medical devices. Clinical charting system functions that may be enhanced or simplified from a user standpoint by implementing data exchange web services include updating data for individual patients, scheduling, billing, and other administrative tasks. The provision of web services to simplify these tasks from a user standpoint also allows for authentication methods to be utilized to authorize a web service request for ensuring data privacy and protection.

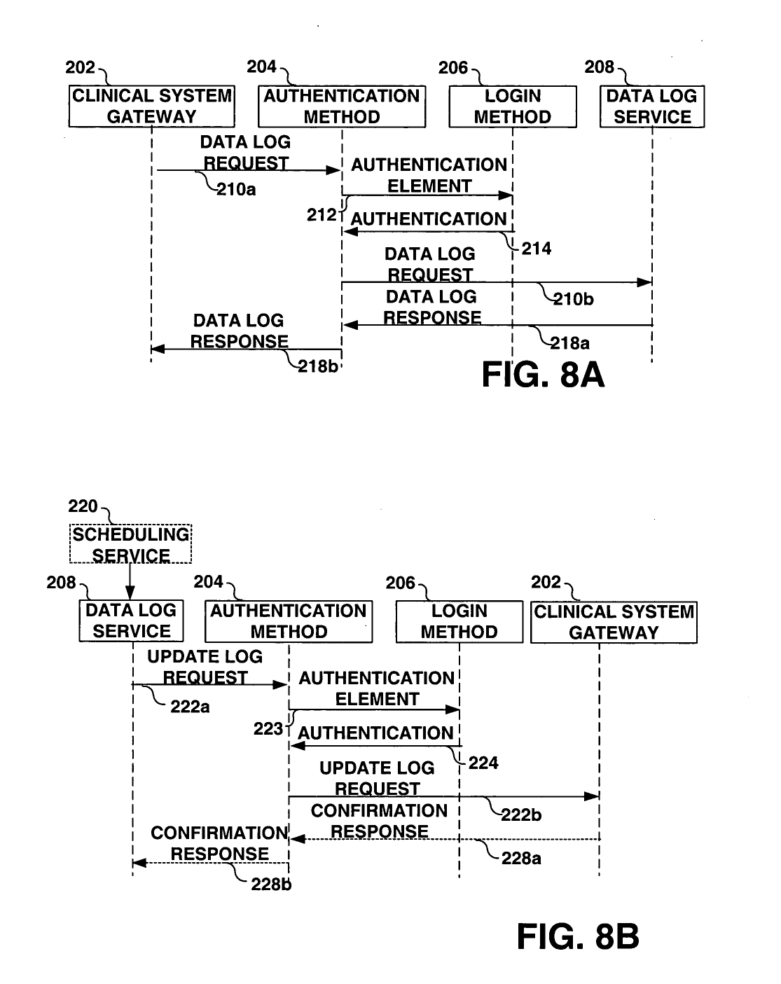

FIG. 8A is a schematic diagram summarizing the steps performed in invoking and executing a web service for informing a clinical charting system of new data received by a central database. An individual patient may be scheduled for remote monitoring via a home monitoring device capable of transferring data to a central database residing on a host server. However, the clinical charting system has no way of “knowing” whether the remote monitoring session has occurred unless a user intervenes by viewing each patient record in the central database. The user then may have the task of manually updating the clinical charting system with any new remote monitoring data or re-scheduling a remote monitoring session if a scheduled monitoring session did not occur.

The data log web service methods summarized in the schematic diagram of FIG. 8 allow a clinical charting system to invoke a web service for informing the clinical charting system of any new monitoring sessions that have occurred for any patients or device serial numbers enrolled in the particular clinical system. A clinical system gateway 202 may invoke the data log web service 208 by transferring a data log request 210a/210b. The data log request 210a includes an authentication element 212 which may identify the system gateway 202 or an individual user by a user identification and password or some type of authorization parameter. Thus the data log web service request 210a is first handled by an authentication web method 204, which receives the authentication element 212 and transfers the authentication element 212 to a login method 206. If the authentication element 212 is valid, the login method 206 responds with an authentication authorization 214, which enables the data log request 210b to be forwarded to the data log service 208 by the authentication web method 204.

The data log request 210b may additionally include optional start and end time parameters indicating the period of time for which a new monitoring session log is desired. The data log service 208 responds to the data log service request 210b by invoking a storage web service to retrieve a log of monitoring sessions from a central database. The data log service 208 then provides a data log response 218a/218b which is transferred via the authentication web method 204 back to the clinical system gateway 202. Thus the authentication web method 204 acts to ensure that only authorized users are given access to the central database and the data log web service 208. An authentication web method 204 may additionally provide data validation, encryption, decryption or other security functions. Authentication web method 204 allows existing system firewalls to be overcome, which has previously been a major challenge in connecting computer systems, by verifying an authentication element.

The data log response 218a/218b will include a list of any monitoring sessions logged to the central database during the requested time interval or since a previous data log web service request. Data log service 208 may utilize a translation web service for translating the data log to a format usable by the system gateway 202. The monitoring session data log for patients or device serial numbers registered with the particular clinical charting system will be provided. Each monitoring sessions that has been logged may be identified by patient identification or device serial number, a date and time, whether the session data was obtained remotely or by an office visit, or other identification code.

Based on the received data log information, the clinical charting system may run an application for deriving if any individual patient monitoring sessions are overdue or missed. Thus, the data log web service 208 enables users of a clinical charting system to easily track the occurrence of new monitoring sessions as well as recognize missed monitoring systems.

The schematic diagram of FIG. 8A illustrates the invocation of a web service in a “pull” fashion, i.e., a client system has initiated the web service request. Web services implemented for use with medical device systems may also operate in a “push” fashion wherein a web service initiates a specific service.

FIG. 8B is a schematic diagram summarizing operations performed in invoking and executing a web service in a “push” fashion. In this example, the data log web service 208 initiates an update data log request 222a to allow the web service 208 to inform a clinical system gateway 202 of monitoring sessions that have been logged over a particular interval of time or since a previous update. A scheduling web service 220 may optionally control when data log service 208 initiates an update log request 222a. In general, data exchange web services may include methods to set-up, schedule, and control when other web services are initiated, invoked or stopped by an application or another web service.

The update log request 222a may be received first by an authentication method 204 to obtain authorization by a login method 206 based on validation of an authentication element 223, which may be an authentication ticket or a user identification and password. Once the login method 206 authorizes authentication 224, the update log request 222b passes monitoring session log information to the clinical system gateway 202. Clinical system gateway 202 may optionally provide a confirmation response 228a/228b to data log web service 208 via authentication web method 204 to confirm successful transmission and receipt of the updated monitoring log information.

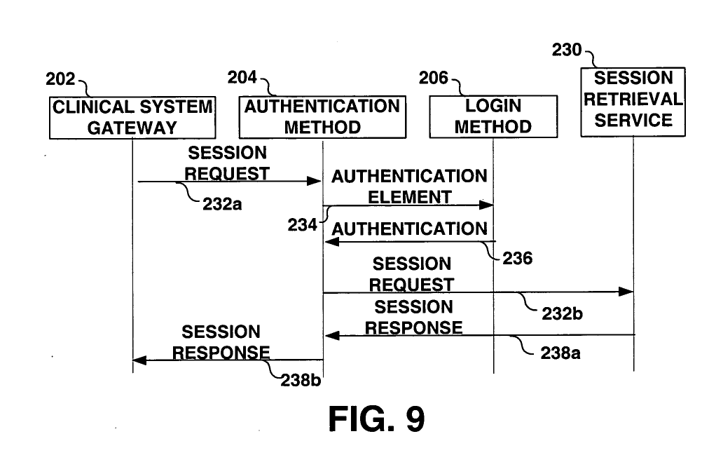

FIG. 9 is a schematic diagram summarizing operations performed in invoking and executing a web service for retrieving monitoring session data. Once a data log update has been received by a clinical charting system as described according to the methods of FIG. 8A or 8B, the charting system may invoke a web service for retrieving specific monitoring session data for any of the logged monitoring sessions. Clinical system gateway 202 invokes session retrieval web service 230 by initiating a session request 232a/232b. The session request 232a may be authenticated first by authentication web method 204 which passes an authentication element 234 of session request 232a to login method 206 in order to receive authentication authorization 236, after which the session request 232b is transferred to the session retrieval web service 230. The session request 232b may contain a list of one or more monitoring sessions to be retrieved with each monitoring session being identified by identifier code provided by the data log update web service.

The session retrieval web service 230 provides a session response 238a/238b to the clinical system gateway, which may be transferred via the authentication web method for security purposes. The session response 238a/238b will include a data listing of each requested monitoring session in a format, e.g. XML, that is readable by the clinical charting system and compatible for automated entry into electronic patient records. The clinical charting system may then run an application to update individual patient records with received monitoring session data. Monitoring session data may be requested in one or more output formats, which can be provided by invoking a translation web service. For example, monitoring session data may be requested in a web viewable form in addition to a format suitable for automated entry into electronic patient records.

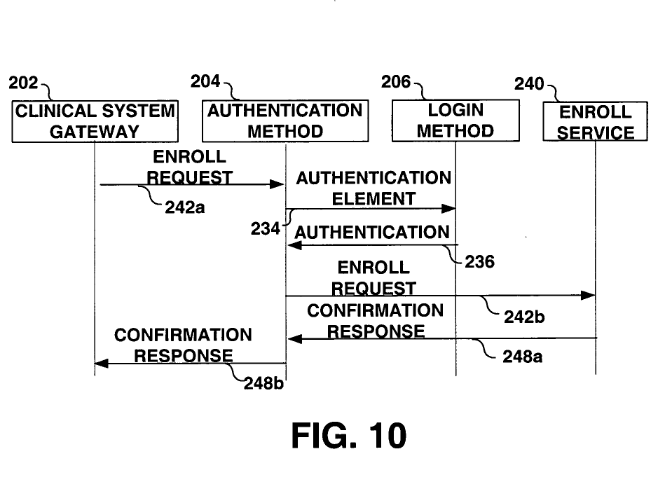

FIG. 10 is a schematic diagram summarizing operations performed in invoking and executing an enrollment web service for automatically registering patients enrolled in a clinical charting system in a central database. New patients receiving a medical device system will generally need to be entered in a clinical charting system and enrolled in a central database provided on a host server or contained by a web service. An enrollment web service may be provided to allow patient data that has been registered in one system, either the clinical charting system or central database, to be automatically enrolled in the other system(s), saving a user time by not requiring patient data to be manually entered into multiple systems. An enrollment web service may operate in either a “push” or a “pull” system as described previously. In a “pull” system, a clinical charting system may invoke an enrollment web service on a periodic basis or whenever new patients have been registered in the clinical charting system such that the new patients are automatically enrolled in a central database or other designated third party system. In a “push” system, an enrollment web service may request a list of new patients from a clinical charting system for enrollment in a central database or other third party system.

In FIG. 10, a “pull” operation is illustrated wherein clinical system gateway 202 issues an enrollment request 242a/242b, which may include an authentication element 234 that is first transferred by an authentication web method to login method 206 for authentication authorization 236 as described previously. The enrollment request 242b, containing new patient record data, may then be transferred to enrollment web service 240. Enrollment web service 240 may utilize a storage web service for adding the patient data to a central database and may utilize translation web services as needed for translating patient data to a format compatible for storage. Enrollment web service 240 may issue a confirmation response 248a/248b to clinical system gateway 202 via authentication web method 204 to confirm successful enrollment of the new data.

Thus, a data exchange system for use with medical device systems has been described which includes the use of web services to allow collaboration and interoperability between a medical device system, and a central database or other data storage system, and clinical or other third party systems, regardless of the operating systems used or application languages running in these different systems. Numerous advantages exist in providing data exchange web services for use by medical data storage systems that rely on separate, often proprietary, applications. Translation, storage and analysis functions may be performed across systems, allowing databases, expert analysis systems, decision support systems, and charting and administrative systems to be integrated while still providing security of these systems. Data exchange web services can provide a common interface for any device format, regardless of the device model or version, thereby eliminating repetitive programming and engineering efforts with each new device release.

It is recognized that numerous variations of the types of web services described herein may be conceived by one of ordinary skill in the art having the benefit of the teachings provided herein. The specific embodiments and examples described herein therefore are intended to be illustrative of the concepts of the present invention and should not be considered limiting with regard to the following claims.

1. A system for exchanging medical data, the data exchange system comprising:
means for acquiring medical data;
means for handling medical data wherein medical data may be stored, analyzed, or displayed;
one or more web services for performing a data exchange function between the means for acquiring medical data and the means for handling medical data.

2. The system of claim 1, wherein one of the one or more web services is a translation web service.

3. The system of claim 2 wherein the translation web service includes an input method for receiving medical data in a first format and an output method for returning medical data to an invoking application in a second format.

4. The system of claim 1 wherein one of the one or more web services is an analysis web service.

5. The system of claim 4 wherein the analysis web service includes an analysis method for performing a requested data analysis function on the specified data and returning the analysis results to an invoking application.

6. The system of claim 1 wherein one of the one or more web services is a storage web service.

7. The system of claim 6 wherein the storage web service includes a method for writing data to a data storage system.

8. The system of claim 6 wherein the storage web service includes a method for retrieving data from a data storage system.

9. The system of claims 7 or 8, wherein the data storage system is any of a relational database system; a file system; an XML file system, or a medical device.

10. The system of claim 1 wherein one of the one or more web services is a multifunction web service.

11. The system of claim 10 wherein the multifunction web service invokes any of a translation web service, an analysis web service, and a storage web service.

12. The system of claim 11 wherein the multifunction web service is a data log service for informing a first data storage system of a new data set entered into a second data storage system.

13. The system of claim 12 wherein a new data set comprises a record of a monitoring session performed by a medical device.

14. The system of claim 11 wherein the multifunction web service is a session retrieval service for retrieving monitoring session data recorded by a medical device and stored in a data storage system.

15. The system of claim 11 wherein the multifunction web service is an enrollment web service for registering a patient or medical device record newly enrolled in a first data storage system into a second data storage system.

16. The system of claim 1 wherein the means for acquiring medical data is an external medical device having telemetric communication with an implantable medical device for receiving data from the implantable medical device and storing the data.

17. The system of claim 1 wherein the means for acquiring medical data is an external monitoring or therapy delivery device capable of acquiring and storing medical data.

18. The system of claim 1 wherein the means for acquiring medical data is an implantable medical device.

19. A system for exchanging medical data, the data exchange system comprising:
a first means for handling medical data wherein medical data may be stored, analyzed or displayed and wherein first medical data handling means is provided with a communication connection;
a second means for handling medical data wherein medical data may be stored, analyzed, or displayed and wherein second medical data handling means is provided with a communication connection;
one or more web services for performing a data exchange function between the first and second data handling means via a communication connection.

20. A system for exchanging data between a medical device and a remote data handling system, the data exchange system comprising:
a medical device capable of storing medical data and transferring the data via a communication connection;
means for electronically storing data in a remote data handling system and for receiving data from the medical device via the communication connection;
one or more web services for performing a data exchange function wherein the web service may be invoked by an application running on the medical device or on the remote data handling system to allow data to be exchanged between the medical device and the remote data handling system.
